(19) United States
(12) Patent Application Publication
(10) Pub. No.: US 2010/0132355 A1
(43) Pub. Date: Jun. 3, 2010

(54) Internal Combustion Engine

(75) Inventors: Karsten Michels, Magdeburg (DE); Jens Kühlmeyer, Gifhorn (DE); Dirk Hagelstein, Braunschweig (DE); Manfred Kloft, Konigslutter (DE)

Correspondence Address: MANFRED BECK PA, PO BOX 431255, SOUTH MIAMI, FL, 33243-1255, US

(73) Assignee: Volkswagen Aktiengesellschaft, Wolfsburg (DE)

(21) Appl. No.: 12/688,888

(22) Filed: Jan. 17, 2010

Related U.S. Application Data
(63) Continuation of application No. PCT/EP2008/004880, filed on Jun. 18, 2008.

(30) Foreign Application Priority Data
Jul. 17, 2007 (DE) 10 2007 033 175.6

(51) Int. Cl. F02B 33/44; F02M 15/00

(52) U.S. Cl. 60/605.1; 123/542; 60/605.2

(57) ABSTRACT

An internal combustion engine, in particular an Otto-cycle engine, has an exhaust gas turbocharger and a mechanical charger, wherein a compressor of the exhaust gas turbo charger is disposed upstream of the mechanical charger in the air channel for combustion air such that the compressor of the exhaust gas turbocharger draws combustion air directly from an air filter. A first charge air cooler is disposed downstream of the compressor of the exhaust gas turbocharger and upstream of the mechanical charger. A second charge air cooler is disposed downstream of the mechanical charger. The first charge air cooler, the second charge air cooler, the mechanical charger, and an intake manifold are all arranged in a single charge air cooling module, wherein direct fuel injection into the combustion chambers of the internal combustion engine is provided for supplying fuel.

### CROSS-REFERENCE TO RELATED APPLICATIONS

This application is a continuation, under 35 U.S.C. §120, of copending International Application No. PCT/EP2008/004880, filed Jun. 18, 2008, which designated the United States; this application also claims the priority, under 35 U.S.C. §119, of German Patent Application No. DE 10 2007 033 175.6, filed Jul. 17, 2007; the prior applications are herewith incorporated by reference in their entirety.

### BACKGROUND OF THE INVENTION

### FIELD OF THE INVENTION

The invention relates to an internal combustion engine, in particular an Otto cycle engine, with an exhaust gas turbocharger and a mechanical charger, wherein a compressor of the exhaust gas turbocharger is disposed in the air channel for combustion air upstream of the mechanical charger.

The combined charging of an Otto cycle engine with a mechanical charger and an exhaust gas turbocharger is for example disclosed in U.S. Pat. No. 4,903,488 and provides the ability to significantly expand the input output map. As a result of the quick response characteristic of the mechanical charger at low revs, the so-called turbo lag can in this case be avoided, and thus the exhaust gas turbocharger can be designed for the upper range of the rotational speed and rated power output. Because of the broad usable torque plateau, long gear ratios can be used, which is called downspeeding. The long gear ratios together with a shifting of the operating range by a so-called downsizing allow substantial fuel savings when compared to conventional engines. Under the constraints of mass production, moderate increases in the maximum effective mean pressure (increases from 22 bar to about 24 bar) and increases in the specific engine output (90 kW/L to about 100 kW/L) are possible with this technology by further downsizing for the purpose of tapping additional potential with respect to fuel consumption. However, in order to achieve truly significant improvements, a leap in technology would be necessary.

A substantial increase of the effective mean pressure as well as a substantial increase of the specific engine output and thus the degree of downsizing are however associated with the following disadvantages of the above-described internal combustion engine. Extremely long air paths upstream and downstream of the compressor of the exhaust gas turbocharger are necessary as a result of the package. Since the mechanical charger is the first charging unit, a large volume including the air to charge air cooler must first be filled before the intake manifold pressure increases and torque can be built up. This reduces the possible potential in terms of the response behavior, so that a noticeable response delay would arise in case of an additional high pressure charging. The high losses in intake pressure upstream of the compressor of the exhaust gas turbocharger, which result from the long intake path, have an especially negative impact on the performance of the exhaust gas turbocharger in the case of a high pressure charging, which reduces the possible operating range of the exhaust gas turbocharger and thus the operating range of the engine. The operating point on the compressor characteristic map is in the low-end torque range very close to the compressor surge limit, which prevents a further substantial increase in torque in the low rotational speed range. The limitation by the surge limit also prevents the use of a much larger compressor that would be required for a further substantial increase in the rated power output. Any further increase in the power output requires additional measures for protecting the components, such as enriching the fuel air mixture, that are counteractive to lowering fuel consumption and again wipe out the main advantage of the downsizing. Any further increase in torque requires a higher pressure ratio and a longer operation duration of the mechanical charger, which also reduces the achievable fuel consumption advantage. The amount of heat to be dissipated or cooling power grows disproportionately, which requires large effective cooling surfaces.

German Patent Application Publication No. DE 199 28 523 A1 discloses an internal combustion engine with an exhaust gas turbocharger and a supercharger, wherein the compressor of the exhaust gas turbocharger is disposed upstream of the mechanical charger.

### SUMMARY OF THE INVENTION

It is accordingly an object of the invention to provide an engine configuration which overcomes the above-mentioned disadvantages of the heretofore-known engine configurations of this general type and which allows an extreme downsizing for an internal combustion engine through the use of high pressure charging with the goal of reducing fuel consumption.

With the foregoing and other objects in view there is provided, in accordance with the invention, an engine configuration, including:

an internal combustion engine including combustion chambers, a direct fuel injection into the combustion chambers for supplying fuel, an intake manifold, an air channel for combustion air, an air filter, an exhaust gas turbocharger, a mechanical charger, a first charge air cooler, and a second charge air cooler;

the exhaust gas turbocharger having a compressor disposed in the air channel for combustion air upstream of the mechanical charger and the compressor of the exhaust gas turbocharger being disposed in the air channel for combustion air such that the compressor of the exhaust gas turbocharger draws in combustion air directly from the air filter;

the first charge air cooler being disposed downstream of the compressor of the exhaust gas turbocharger and upstream of the mechanical charger;

the second charge air cooler being disposed downstream of the mechanical charger; and

the first charge air cooler, the second charge air cooler, the mechanical charger and the intake manifold being arranged in a single charge air cooling module.

In other words, according to the invention, there is provided an internal combustion engine, in particular an Otto cycle engine (spark ignition engine), with an exhaust gas turbocharger and a mechanical charger, wherein the compressor of the exhaust gas turbocharger is disposed in the air channel for combustion air such that the compressor of the exhaust gas turbocharger draws in combustion air directly from an air filter, wherein a first charge air cooler is provided downstream of the compressor of the exhaust gas turbocharger and upstream of the mechanical charger, wherein a second charge air cooler is provided downstream of the mechanical charger, wherein the first charge air cooler, the second charge air cooler, the mechanical charger, and the intake manifold (intake passage) are arranged in a single charge air cooling module, and wherein a direct fuel injection into combustion chambers of internal combustion engine is provided for fuel delivery.

This has the advantage that the combination of features according to the invention provides in sum a synergy effect, which exploits the following separate advantages in combination, resulting in an unexpected leap in technology: The compressor of the exhaust gas turbocharger draws in uncompressed air from the environment, so that the compressor volume flow increases with the same mass flow and the critical operating points in the low-end torque range move away from the surge limit. The compressor efficiency increases, which improves both the response behavior and the acceleration behavior of the exhaust gas turbocharger, and which also increases the achievable low-end torque. In addition, due to the mitigation of the surge limit problem, larger compressors can be used, which is the prerequisite for a higher specific engine output. As a so-called volume mover, the mechanical charger can move the highest possible mass flows due to the air being pre-compressed by the exhaust gas turbocharger. In this manner, it is possible to realize extremely high cylinder charges with very good response behavior. For equal engine torque, the drive power for the mechanical charger decreases, which means a gain in torque or, when the torque is kept the same, this means a fuel consumption advantage. Small intake pressure losses upstream of the compressor of the exhaust gas turbocharger arise from the fact that the compressor of the exhaust gas turbocharger draws directly from the air filter and thus there are short air paths upstream of the compressor of the exhaust gas turbocharger. The thermal load of the mechanical charger is minimized by re-cooling the compressed air with the help of an intercooling. The total amount of heat to be dissipated is reduced when compared to a solution without an intercooling, so that the required cooling surface does not increase inordinately even in case of a performance increase. A short air path from the intercooler (charge air cooler) to the mechanically driven compressor and from there into the intake manifold is achieved by the integral component in the form of the charge air cooling module, which combines the first charge air cooler, the mechanical charger, the second charge air cooler and the intake manifold in a module. Through the use of direct injection it is possible to exploit internal cooling effects caused by the evaporation of the fuel and thus to reduce the tendency of the engine to knock. In this way, even in case of high pressure charging, relatively high compression ratios can still be achieved, which is a necessary precondition for a low part-load fuel consumption. Effective mean pressures in the range of 24-28 bar and even effective mean pressures of more than 30 bar at specific torque values of about 235 Nm/L can be achieved, and specific engine outputs in the range of 95 to 125 kW/L and even greater than 130 kW/L can be achieved.

According to another feature of the invention, the first and/or the second charge air cooler is embodied as a water-cooled charge air cooler, in order to make it possible to have a volume of preferably less than three liters (3,000 cc) between the mechanical charger and an inlet port.

According to an expedient feature of the invention, the mechanical charger and the intake manifold are arranged and configured such that a volume in the air channel for combustion air between the mechanical charger and an inlet port is less than three liters.

According to another feature of the invention, an external exhaust gas recirculation is provided.

According to a further feature of the invention, the exhaust gas turbocharger is configured as part of the charge air cooling module.

Depending on the mounting situation and, respectively, the installation space conditions of the internal combustion engine, the exhaust gas turbocharger, which takes in air from the air filter box, can be arranged on the side of the internal combustion engine opposite the charge air cooling module or on the same side. In the case of an opposite arrangement, the exhaust gas turbocharger is preferably disposed in a geodetically upper or high position close to the cylinder head which results in a short link for the charge air leaving the exhaust gas turbocharger with respect to the entry into the first charge air cooler.

The flow connection between the outlet of the compressor and the entry into the first charge air cooler can be further reduced in case the charge air cooling module and the exhaust gas turbocharger are disposed on one side.

In the context of this invention, when it is mentioned that the exhaust gas turbocharger draws its combustion air directly from an air filter, this means that the flow connection between the air filter and the inlet of the compressor of the exhaust gas turbocharger is designed to be as short as possible. A lengthening of this intake path means flow losses and a deterioration of the response behavior.

The optionally provided additional external exhaust gas recirculation (EGR) offers, while maintaining a lambda-1-concept, i.e. an operation of the internal combustion engine as much as possible with a stoichiometric air-fuel ratio, and with a controlled three-way catalytic converter under part-load the potential, through the dethrottling of the engine, to save charge-exchange work and hence to reduce fuel consumption. At high loads during charging operation, the exhaust gas temperatures and thus the need for enriching the fuel air mixture for protecting components can be reduced by a cooled external exhaust gas recirculation due to the increased charge mass in the cylinder.

Other features which are considered as characteristic for the invention are set forth in the appended claims.

Although the invention is illustrated and described herein as embodied in an internal combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of a preferred embodiment of an internal combustion engine according to the invention;

FIG. 2 is a schematic diagram of an alternative preferred embodiment of an internal combustion engine according to the invention with a low-pressure exhaust gas recirculation; and

FIG. 3 is a schematic diagram of an alternative preferred embodiment of an internal combustion engine according to the invention with a high-pressure exhaust gas recirculation.

### DESCRIPTION OF THE PREFERRED EMBODIMENTS

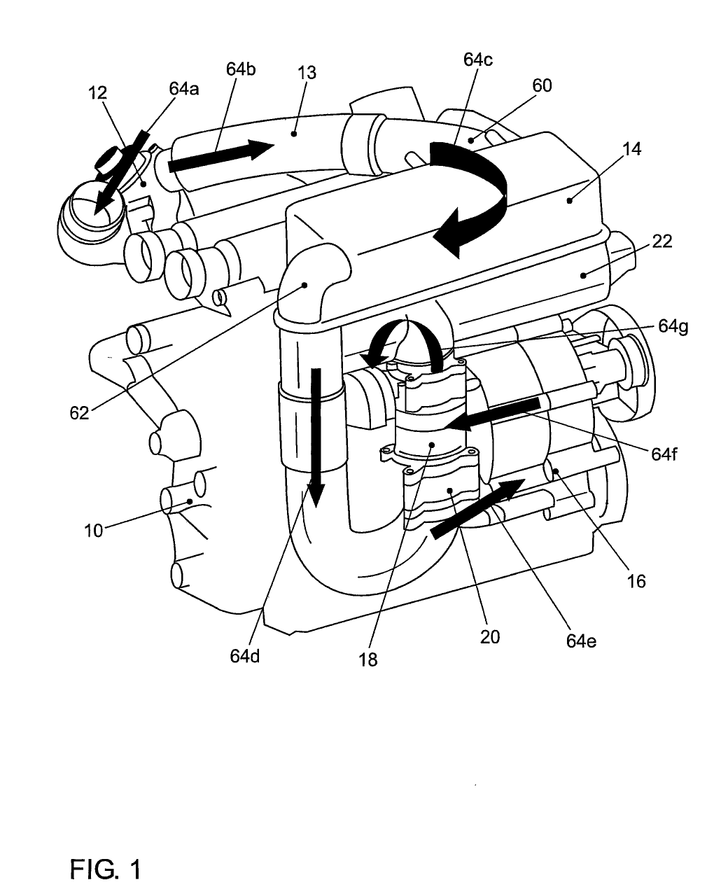

Referring now to the figures of the drawings in detail and first, particularly, to FIG. 1 thereof, there is shown a first preferred embodiment of an internal combustion engine according to the invention including an engine block 10, a compressor 12 of an exhaust gas turbocharger, a charge air line 13, a first charge air cooler 14, a mechanical charger 16, a bypass channel 18 for the mechanical charger 16 with a control flap (control valve) 20 disposed therein and a second charge air cooler 22. The first charge air cooler 14, the mechanical charger 16, the bypass channel 18, the second charge air cooler 22 and the intake manifold (intake passage), which is not visible in FIG. 1, are combined into a charge air cooling module, resulting in very short distances for the air channel for combustion air between these components.

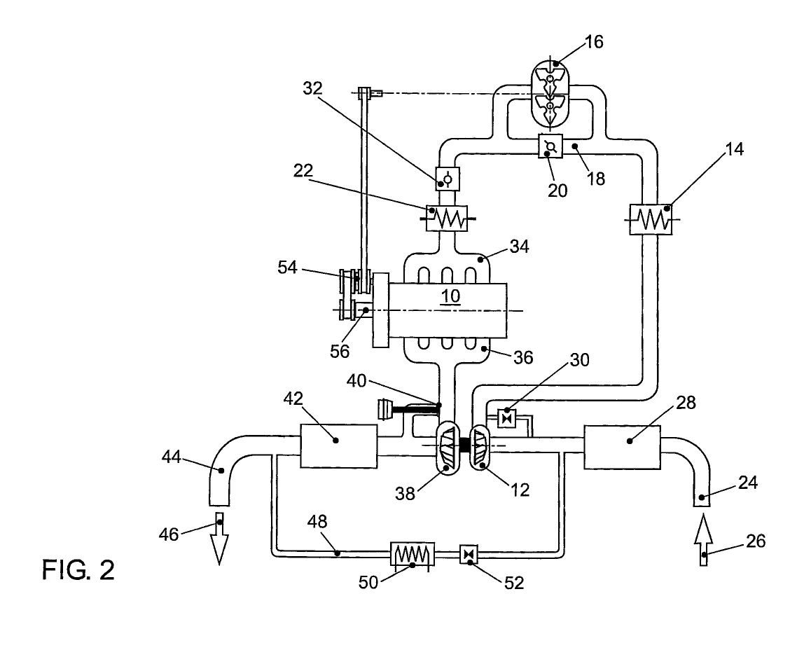

A schematic diagram of such an internal combustion engine with an external exhaust gas recirculation (EGR) is shown in FIG. 2. Functionally identical parts are denoted by the same reference numerals as in FIG. 1, so that reference to the above description of FIG. 1 is made for explaining those parts. The internal combustion engine includes, in the combustion air channel (combustion air duct), in addition to the components already apparent from FIG. 1, an inlet 24 for combustion air 26, an air filter 28, a divert-air valve 30 bypassing the compressor 12, a throttle valve 32 and the intake manifold 34.

The internal combustion engine includes, in the exhaust gas channel, an exhaust gas manifold 36, a turbine 38 of the exhaust gas turbocharger, a wastegate 40 bypassing this turbine 38, a catalytic converter 42, an outlet 44 for exhaust gas 46 and a low-pressure EGR line 48 with an EGR cooler 50 and an EGR valve 52, wherein a low-pressure EGR line 48 branches off from the exhaust gas channel downstream of the catalytic converter 42 and opens into the combustion air channel upstream of the compressor 12.

The mechanical charger 16 is connected, via a magnetic clutch 54, with a crankshaft 56 of the internal combustion engine.

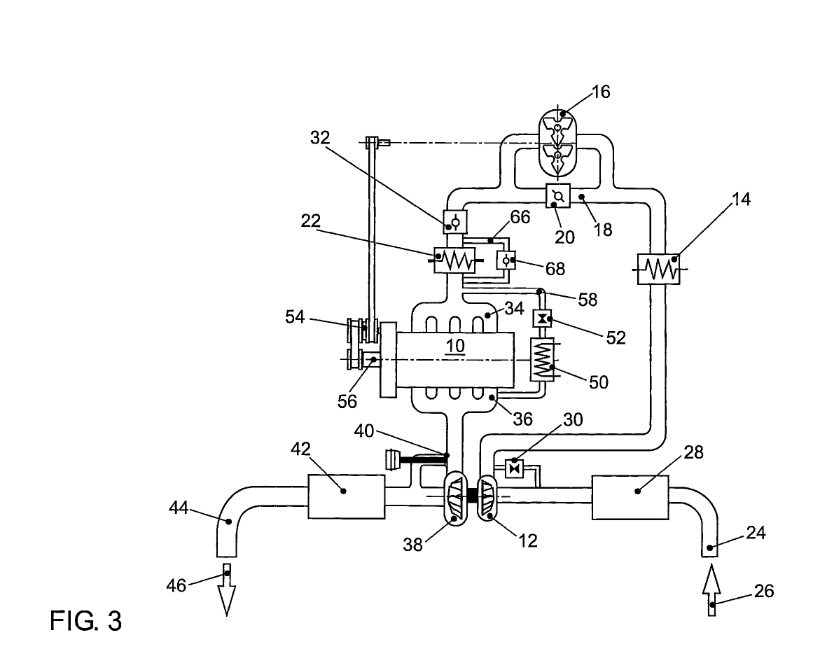

In the alternative embodiment shown in FIG. 3 functionally identical parts are denoted by the same reference numerals as in FIGS. 1 and 2, so that reference to the above description of FIGS. 1 and 2 is made for explaining those parts. Instead of the low-pressure EGR line as in the embodiment according to FIG. 2, a high-pressure EGR line 58 is provided. This high-pressure EGR line 58 branches off from the exhaust gas manifold 36 and opens into the intake manifold 34.

The combination of features in accordance with the invention of (a) a mechanical charger 16 downstream of the compressor 12, (b) extremely short air paths upstream of the compressor 12 by arranging the compressor 12 directly downstream of the air filter 28, (c) re-cooling the compressed air 26 through an intercooling at the first charge air cooler 14, (d) a short air path from the first charge air cooler 14 to the mechanical charger or mechanically driven compressor 16 and from the mechanical charger 16 to the intake manifold 34 by integration of the first charge air cooler 14, the mechanical charger 16, the second charge air cooler 22 and the intake manifold 34 into a single charge air cooling module, (e) a direct injection, and (f) an optional EGR achieves in an unexpected and surprising way an extension of the characteristic map area, a higher degree of downsizing and greater reduction in fuel consumption. In a surprising and unexpected way it is possible to achieve effective mean pressures of greater than 30 bar and specific engine outputs of greater than 130 kW/L without the restrictions mentioned above that occur in conventional internal combustion engines.

In FIG. 1, arrows 64a to 64g illustrate a flow path of the combustion air, wherein the control flap 20 is closed so that the combustion air flows through the mechanical charger 16 along all the arrows 64a to 64g. In case the control flap 20 is open, the compressor 16 (arrows 64e and 64f) is being bypassed. As is immediately apparent, the two charge air coolers 14 and 22, although being arranged side by side directly adjacent one another, there is no direct, flow-conducting connection from one charge air cooler to the other charge air cooler, but there is merely a connection either through the bypass channel 18 or the mechanical charger 16. The two charge air coolers 14 and 22 are embodied as water-cooled charge air coolers and have a common water-cooling circuit. This water-cooling circuit is also integrated into the charge air cooling module.

In all above-described embodiments, it is optionally possible to bypass the second charge air cooler 22 with a bypass 66, wherein a switching flap 68 is disposed in this bypass 66. This bypassing of the second charge air cooler 22 occurs preferably when the control flap 20 is open and the compressor is thus bypassed and a single charge air cooler, i.e. the first charge air cooler 14, can provide a sufficient cooling of the charge air. The flow losses and throttling losses of the second charge air cooler 22 are then advantageously eliminated.

The technical data for the charge air coolers are preferably as shown in the table below:

| | Driving up-hill | |
|---|---|---|
| | at 2000 rpm | Vₘₐₓ |
| Vehicle speed [km/h] | 37 | 240 |
| Air mass flow engine [kg/h] | 250 | 630 |
| Ambient temperature [° C.] | 30 | 40 |
| Intake temperature [° C.] | 45 | 45 |
| Charge air temp. 1st ch. air | 120-160 | 145-205 |
| cooler 14 input [° C.] | | |
| Charge air temp. 1st ch. air | 35-65 | 100-140 |
| cooler 14 output [° C.] | | |
| Charge air temp. 2nd ch. air | 120-150 | 100-140 |
| cooler 22 input [° C.] | | |
| Charge air temp. 2nd ch. air | 25-55 | 35-65 |
| cooler 22 output [° C.] | | |

By arranging the air induction point 60 in the first charge air cooler 14, as can be seen in FIG. 1 on the right side at the rear side area, no special measures on its cooler grid for improving the equal distribution of the charge air are required. Due to the diagonally opposite position of the air induction point 60 and an air discharge point 62 for the charge air, a good uniform distribution of the charge air over the cooler core is achieved. The uniform distribution of the charge air across the cooler core of the second charge air cooler 22 is dictated, i.e. forced, by the location of the inlet ports, as they alternately tap off the air along the entire width of the cooler grid and feed it to the individual cylinders of the internal combustion engine.

What is claimed is:

1. An engine configuration, comprising:
an internal combustion engine including combustion chambers, a direct fuel injection into said combustion chambers for supplying fuel, an intake manifold, an air channel for combustion air, an air filter, an exhaust gas turbocharger, a mechanical charger, a first charge air cooler, and a second charge air cooler;
said exhaust gas turbocharger having a compressor disposed in said air channel for combustion air upstream of said mechanical charger such that said compressor of said exhaust gas turbocharger draws in combustion air directly from said air filter;
said first charge air cooler being disposed downstream of said compressor of said exhaust gas turbocharger and upstream of said mechanical charger;
said second charge air cooler being disposed downstream of said mechanical charger; and
said first charge air cooler, said second charge air cooler, said mechanical charger and said intake manifold being arranged in a single charge air cooling module.

2. The engine configuration according to claim 1, wherein at least one of said first and second charge air cooler is embodied as a water-cooled charge air cooler.

3. The engine configuration according to claim 1, wherein said mechanical charger and said intake manifold are configured and disposed such that a volume in said air channel for combustion air between said mechanical charger and an inlet port is less than three liters.

4. The engine configuration according to claim 1, including an external exhaust gas recirculation.

5. The engine configuration according to claim 1, wherein said exhaust gas turbocharger is configured as part of said charge air cooling module.

6. The engine configuration according to claim 1, including a bypass assigned to said second charge air cooler.

7. The engine configuration according to claim 1, wherein said internal combustion engine is an Otto-cycle engine.
